(19) United States
(12) Patent Application Publication
(10) Pub. No.: US 2025/0207439 A1
(43) Pub. Date: Jun. 26, 2025

(54) Operating Mechanism for Operating a Vehicle Door, in Particular an Exterior Vehicle Door

(71) Applicant: Illinois Tool Works Inc., Glenview, IL (US)

(72) Inventor: Andreas Rudolf, Eibelstadt (DE)

(21) Appl. No.: 18/973,397

(22) Filed: Dec. 9, 2024

(30) Foreign Application Priority Data
Dec. 22, 2023 (DE) 10 2023 136 593.2

(51) Int. Cl. E05B 81/76

(52) U.S. Cl. CPC E05B 81/76

(57) ABSTRACT

The disclosure relates to an actuating mechanism (1) for actuating, in particular unlocking and/or opening, a door (2) of a vehicle, in particular an outer vehicle door. The actuating mechanism (1) includes a manually actuatable handle part (3), a carrier element (4), which is in particular fixedly connected to the handle part (3) via an end region of the carrier element (4), and a bearing (5), in particular a pivot bearing, via which the handle part (3) with the carrier element (4) can be pivoted about an axis of rotation defined by the bearing (5), in particular about an at least substantially horizontally extending axis of rotation defined by the bearing (5), relative to a housing structure of the actuating mechanism (1) and/or relative to a body structure (6) of the vehicle, in particular an outer skin structure of the vehicle. The actuating mechanism (1) further includes a sensor apparatus (7) that detects a pivoting movement of the handle part (3) with the carrier element (4) out of a resting position of the handle part (3).

### RELATED APPLICATION

The present application claims the benefit of German Patent Application No. 10 2023 136 593.2, filed Dec. 22, 2023, titled “Operating Mechanism for Operating a Vehicle Door, in Particular an Exterior Vehicle Door,” the contents of which are hereby incorporated by reference.

### BACKGROUND

In the automotive industry, there is an increasing trend of no longer manually opening and closing doors and flaps of vehicles, in particular exterior doors, in the “classical manner”. Rather, the respective opening and closing movements, and in particular the locking and unlocking of doors, are frequently carried out automatically, in particular electrically. An electric motor is typically used for this purpose, which, upon request, drives a mechanism for locking and unlocking the doors and flaps. To generate a signal for opening or closing to such an in particular electromotive actuator or to a corresponding control device, a sensor system, in particular a switch, can be provided, which generates the desired signal by actuation on the part of the user. Such switches can be configured as push-buttons, which, when pressed in by the user, generate the aforementioned signal.

### SUMMARY

The present disclosure relates generally to an actuating mechanism, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in an isometric view, an exemplary embodiment of the actuating mechanism according to the disclosure for actuating a vehicle door.

FIG. 2 illustrates schematically and in a cross-sectional view, the exemplary embodiment of the actuating mechanism according to the disclosure according to FIG. 1.

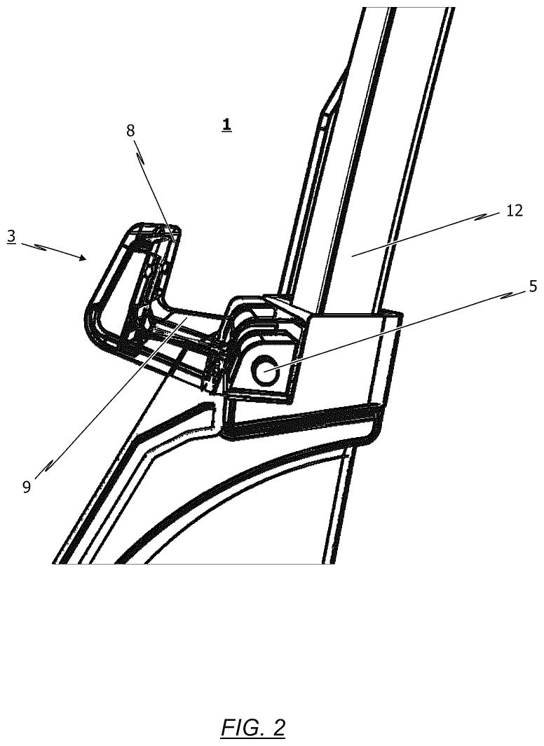

FIG. 3 illustrates schematically a further cross-sectional view of the exemplary embodiment of the actuating mechanism according to the disclosure according to FIG. 1.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to an actuating mechanism for actuating vehicle doors, in particular for unlocking and opening an outer door of a vehicle. The disclosure further relates to a corresponding vehicle door having such an actuating mechanism.

In addition to these switches for unlocking a door, pull handles are required in order to be able to pull open the door in question after unlocking. The handle and push-buttons are often difficult to reach with a single hand movement, so that the unlocking and pulling open of doors frequently must be done separately. Moreover, such pull handles, via which a vehicle door is manually pulled open after unlocking, that is to say opened, are typically arranged in a region near the vehicle door, which are particularly difficult to reach for smaller persons, for example children.

Therefore, the problem addressed by the present disclosure is to specify an actuating mechanism for actuating a vehicle door, which can be used for unlocking and simultaneously opening the vehicle door in a single movement. Moreover, there is a need for the actuating mechanism to reliably detect an opening request on the part of the operator, even if the operator does not manipulate a handle part of the actuating mechanism, for example due to poor accessibility of the handle part, in a single, predetermined direction of movement.

In one example, an actuating mechanism for actuating a vehicle door comprises a manually actuatable handle part connected to a carrier element via its end region. This carrier element and handle part are pivotable about an axis of rotation defined by a bearing, relative to either the housing structure of the mechanism or the body structure of the vehicle. A sensor apparatus detects the pivoting movement of the handle part with the carrier element from its resting position. The handle part, designed as a lever element, translates vertical and horizontal forces into a pivoting motion about the axis of rotation. This lever configuration includes regions aligned vertically along the outer skin of the vehicle and horizontally, transitioning into the carrier element at the location of the bearing. The axis of rotation is located at the intersection of a line extending along the horizontal handle part and another extending along the carrier element. The handle part and carrier element may be integrally formed from plastic. A biasing element, such as a leg spring, biases the handle part into its resting position, with one leg supported on the carrier element and the other on the housing structure or vehicle body. The pivoting movement is limited by a stop, preferably to a maximum of 20 degrees. The sensor apparatus detects the handle part's pivoting motion relative to the vehicle body and generates an electrical signal to unlock the door. The handle part transfers its motion during manual actuation to the sensor apparatus, facilitating its activation. The bearing may be a pivot bearing, and the axis of rotation is typically horizontal. The sensor apparatus can be a microswitch, and the biasing element can be a spring. This actuating mechanism may be installed on or near the A, B, or C pillars of the vehicle's body structure.

Accordingly, the disclosure relates in particular to an actuating mechanism for actuating, in particular unlocking and/or opening, a door of a vehicle. The vehicle door is in particular an outer vehicle door.

The actuating mechanism comprises a manually actuatable handle part as well as a carrier element, which is in particular fixedly connected to the handle part via an end region of the carrier element.

Furthermore, a bearing is used, which is in particular configured as a pivot bearing, and via which the handle part, together with the carrier element, can be pivoted about an axis of rotation defined by the bearing relative to a housing structure of the actuating mechanism and/or relative to a body structure of the vehicle, in particular an outer skin structure of the vehicle. The axis of rotation defined by the bearing is preferably an axis of rotation that extends at least substantially in a horizontal direction.

Finally, the actuating mechanism according to the disclosure comprises a sensor apparatus, in particular in the form of a switch, in particular a microswitch, or having a switch, in particular a microswitch, wherein the sensor apparatus is configured so as to detect a pivoting movement of the handle part together with the carrier element out of a resting position of the handle part.

According to preferred implementations of the actuating mechanism according to the disclosure, it is provided that the handle part is designed at least partially or regionally as a lever element and is configured so to transfer a force component acting on the handle part in a vertical direction as well as a force component acting on the handle part in a horizontal direction into respective force components which cause a pivoting of the handle part with the carrier element out of the resting position of the handle part about the axis of rotation defined by the bearing.

The aforementioned force component acting in a vertical direction on the handle part is in particular a force component acting in a downwards vertical direction on the handle part when the actuating mechanism is mounted on or in the vehicle, in particular on or in the vehicle door.

The aforementioned force component acting in a horizontal direction on the handle part is in particular a force component facing away from the vehicle door in a horizontal direction and acting on the handle part.

In the context of the last mentioned design variant of the actuating mechanism according to the disclosure, it is contemplated in particular that the handle part, which is at least partially or regionally configured as a lever element, comprises a region extending at least substantially in a vertical direction as well as a region extending at least substantially in a horizontal direction. The region of the handle part configured at least partially or regionally as a lever element that extends at least substantially in a vertical direction is in particular a vertical direction extending at least substantially parallel to the outer skin of the vehicle.

The aforementioned horizontally extending region of the handle part that is at least partially or regionally configured as a lever element is connected to the end region of the carrier element.

It is preferably provided in particular that bearing of the actuating mechanism is configured/arranged in a region in which the region of the handle part extending at least substantially in the horizontal direction transitions into the carrier element.

In particular, according to embodiments of the actuating mechanism according to the disclosure, it is provided that the axis of rotation defined by the bearing lies at least substantially in a region of an intersection between a straight line extending along the region of the handle part extending in the horizontal direction and a straight line extending along the carrier element.

Advantageously, the handle part and the carrier element of the actuating mechanism according to the disclosure are formed integrally, in particular from a plastic material. The handle part and the carrier element are preferably formed in the course of a spray-molding process.

According to further developments of the actuating mechanism according to the disclosure, it is provided that the actuating mechanism further comprises a biasing element, in particular in the form of a spring, for biasing the handle part (together with the carrier element connected to the handle part) into the resting position of the handle part.

In this context, for example, it is expedient that the biasing element comprises a biased leg spring having two legs and a helically coiled region, wherein the helically coiled region of the leg spring is arranged coaxially and/or concentrically to the axis of rotation, and wherein one leg of the leg spring is supported on the carrier element and another leg of the leg spring is supported on the housing structure of the actuating mechanism and/or on a body structure of the vehicle.

Finally, according to design variants of the actuating mechanism according to the disclosure, it is provided that the actuating mechanism further comprises a stop, or a stop is associated with the actuating mechanism, in order to restrict a pivoting movement of the handle part about the axis of rotation defined by the bearing. For example, the pivoting movement of the handle part is thereby limited to a maximum of 20 degrees, in particular a maximum of 15 degrees, and even more preferably a maximum of 10 degrees.

The disclosure further relates to a door of a vehicle, in particular a vehicle outer door, having an actuating mechanism of the type mentioned above according to the disclosure.

In particular, it is provided that the actuating mechanism is arranged on or in a region of an A, B, or C pillar of a body structure of the vehicle.

The exemplary embodiment of the actuating mechanism 1 according to the disclosure as shown in the drawings serves to actuate, and in particular to unlock and open, a vehicle door 2. For this purpose, the actuating mechanism 1 comprises a manually actuatable handle part 3 and a carrier element 4, which is in particular fixedly connected to the handle part 3 via an end region of the carrier element 4.

It is contemplated, for example, that the handle part 3 and the carrier element 4 are designed together as a monolithic component.

The handle part 3 with the carrier element 4 is pivotable via a pivot bearing 5 about an axis of rotation defined by the pivot bearing 5, which extends at least substantially horizontally, relative to a housing or body structure 6 of the actuating mechanism 1 as well as relative to the body structure 6 of the vehicle.

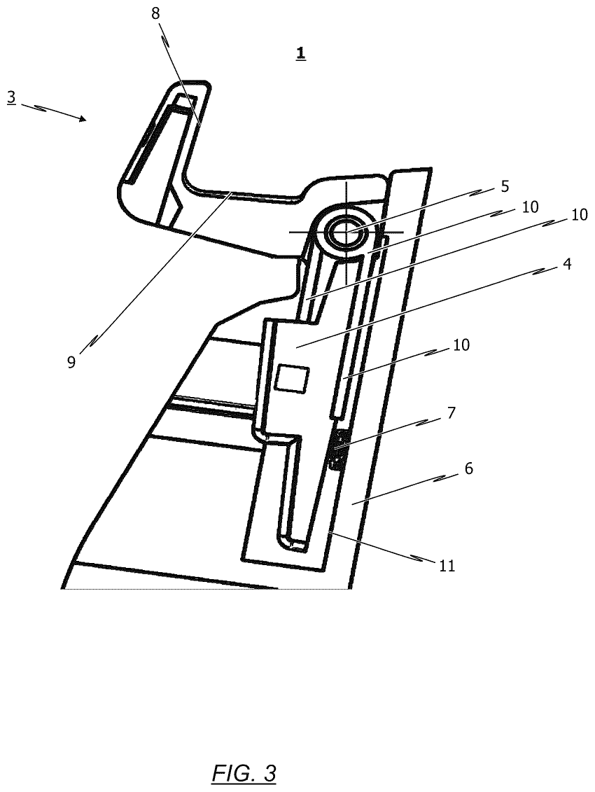

As can be seen in particular from the cross-sectional view according to FIG. 3, the actuating mechanism 1 further comprises a sensor apparatus 7. The first sensor apparatus 7 is in particular a microswitch.

The sensor apparatus 7 is configured so as to detect a pivoting movement of the handle part 3 with the carrier element 4 out of a resting position of the handle part 3.

In particular, the sectional view according to FIG. 3 shows that the handle part 3 is designed at least partially or regionally as a lever element and is configured so to transfer a force component acting on the handle part 3 in a vertical direction, in particular a force component acting on the handle part 3 in a downwards vertical direction, as well as a force component acting on the handle part 3 in a horizontal direction, in particular a force component facing away from the vehicle door 2 in a horizontal direction and acting on the handle part 3, into a force component which causes a pivoting of the handle part 3 with the carrier element 4 out of the resting position of the handle part 3 about the axis of rotation defined by the bearing.

For this purpose in particular, it is provided in the exemplary embodiment of the actuating mechanism 1 according to the disclosure as shown in the drawings that the handle part 3, which is at least partially or regionally configured as a lever element, comprises a region extending at least substantially in a vertical direction, in particular in a vertical direction extending at least substantially parallel to the outer skin of the vehicle, and a region extending at least substantially in a horizontal direction, which is connected to the end region of the carrier element 4. In particular, the handle part 3 can thus have an at least substantially L-shaped cross-sectional geometry.

The bearing 5 is configured in a region in which the region of the handle part 3 extending at least substantially in the horizontal direction transitions into the carrier element 4.

Specifically, the axis of rotation defined by the bearing 5 lies in a region of an intersection between a straight line extending along the region of the handle part 3 extending in the horizontal direction and a straight line extending along the carrier element 4.

According to preferred implementations of the actuating mechanism 1 according to the disclosure, the handle part 3 and the carrier element 4 are integrally formed, that is to say created as a monolithic component, in particular from a plastic material. The handle part 3 can at least regionally also have a cool-touch effect.

It can be seen from the sectional view according to FIG. 3 that the actuating mechanism 1 further comprises a biasing element 10, in particular in the form of a leg spring, wherein the biasing element 10 serves to bias the handle part 3 into its resting position.

Specifically, a biased leg spring having two legs and a helically coiled region is used as the biasing element 10, wherein the helically coiled region of the leg spring is arranged coaxially and/or concentrically to the axis of rotation, and wherein one leg of the leg spring is supported on the carrier element 4 and another leg of the leg spring is supported on the housing structure of the actuating mechanism 1.

Alternatively, however, it is also contemplated that the other leg of the leg spring can support itself on a body structure 6 of the vehicle.

The actuating mechanism 1 further comprises a stop 11 for restricting a pivoting movement of the handle part 3 about the axis of rotation defined by the bearing 5. The pivoting movement is preferably limited to a maximum of 20°, in particular a maximum of 15°, and even more preferably a maximum of 10°.

The disclosure is not limited to the exemplary embodiments of the actuating mechanism 1 as shown in the drawings, but rather results when all of the features disclosed herein are considered together.

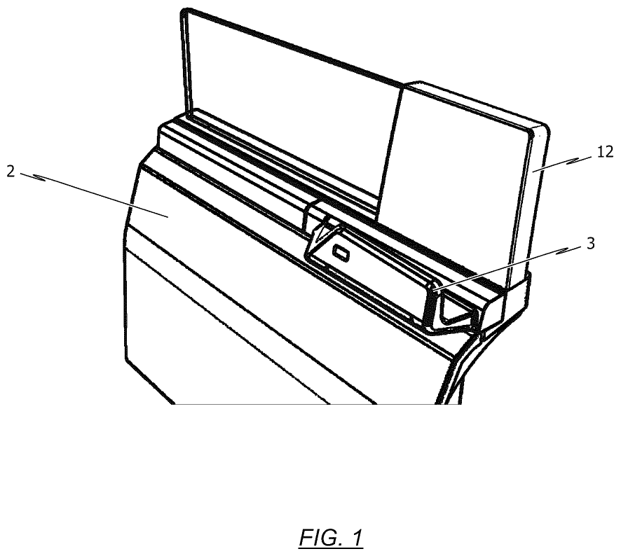

In particular, the disclosure also relates to a vehicle door 2, in particular a vehicle outer door, having a corresponding actuating mechanism 1. The actuating mechanism 1 can be arranged on or in a region of an A, B, or C pillar 12 of a body structure 6 of the vehicle (cf. FIG. 1).

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Actuating mechanism
2 Vehicle door
3 Handle part
4 Carrier element
5 Bearing
6 Body structure
7 Sensor apparatus
8 Vertically extending region of the handle part
9 Horizontally extending region of the handle part
10 Biasing element/leg spring
11 Stop
12 C-pillar

What is claimed is:

1. An actuating mechanism (1) for actuating a door (2) of a vehicle, the actuating mechanism (1) comprising:
a manually actuatable handle part (3);
a carrier element (4) fixedly connected to the handle part (3) via an end region of the carrier element (4);
a bearing (5) via which the handle part (3) with the carrier element (4) can be pivoted about an axis of rotation defined by the bearing (5), relative to a housing structure of the actuating mechanism (1) or relative to a body structure (6) of the vehicle; and
a sensor apparatus (7), wherein the sensor apparatus (7) is configured so as to detect a pivoting movement of the handle part (3) with the carrier element (4) out of a resting position of the handle part (3).

2. The actuating mechanism (1) according to claim 1,
wherein the handle part (3) is designed at least partially or regionally as a lever element and is configured so to transfer a force component acting on the handle part (3) in a vertical direction, as well as a force component acting on the handle part (3) in a horizontal direction, into a force component which causes a pivoting of the handle part (3) with the carrier element (4) out of the resting position of the handle part (3) about the axis of rotation defined by the bearing (5).

3. The actuating mechanism (1) according to claim 2,
wherein the handle part (3), which is at least partially or regionally configured as a lever element, comprises a region extending at least substantially in a vertical direction extending at least substantially parallel to an outer skin of the vehicle, and a region extending at least substantially in a horizontal direction, which is connected to the end region of the carrier element (4).

4. The actuating mechanism (1) according to claim 3,
wherein the bearing (5) is configured in a region in which the region of the handle part (3) extending at least substantially in the horizontal direction transitions into the carrier element (4).

5. The actuating mechanism (1) according to claim 4,
wherein the axis of rotation defined by the bearing (5) lies in a region of an intersection between a straight line extending along the region of the handle part (3) extending in the horizontal direction and a straight line extending along the carrier element (4).

6. The actuating mechanism (1) according to claim 1,
wherein the handle part (3) and the carrier element (4) are formed integrally from a plastic material.

7. The actuating mechanism (1) according to claim 1,
wherein the actuating mechanism (1) further comprises a biasing element (10) for biasing the handle part (3) into its resting position.

8. The actuating mechanism (1) according to claim 7,
wherein the biasing element (10) comprises a biased leg spring having two legs and a helically coiled region, wherein the helically coiled region of the leg spring is arranged coaxially or concentrically to the axis of rotation, and wherein one leg is supported on the carrier element (4) and another leg is supported on the housing structure of the actuating mechanism (1) or on a body structure (6) of the vehicle.

9. The actuating mechanism (1) according to claim 1,
wherein the actuating mechanism (1) further comprises a stop (11) for limiting a pivoting movement of the handle part (3) about the axis of rotation defined by the bearing (5), wherein the pivoting movement is preferably limited to a maximum of 20 degrees.

10. The actuating mechanism (1) according to claim 1,
wherein the sensor apparatus (7) is configured so as to detect a pivoting movement of the handle part (3) relative to the body structure (6) of the vehicle and to generate an electrical signal for unlocking the vehicle door (2).

11. The actuating mechanism (1) according to claim 10,
wherein the handle part (3) is operatively connected to a carrier element (4) in such a way that a movement of the handle part (3) that is generated upon a manual actuation of the handle part (3) is or can be transferred to the sensor apparatus (7) in order to trigger it.

12. A door (2) of a vehicle having an actuating mechanism (1) according to claim 1.

13. The actuating mechanism (1) according to claim 1, wherein the bearing (5), in a pivot bearing.

14. The actuating mechanism (1) according to claim 1, wherein the axis of rotation is a substantially horizontally extending axis of rotation defined by the bearing (5).

15. The actuating mechanism (1) according to claim 1, wherein the sensor apparatus (7) is a microswitch.

16. The actuating mechanism (1) according to claim 7, wherein the biasing element (10) is a spring.

17. The door (2) according to claim 12, wherein the actuating mechanism (1) is arranged on or in a region of an A, B, or C pillar (12) of a body structure (6) of the vehicle.
